(19) United States
(12) Patent Application Publication
(10) Pub. No.: US 2021/0101380 A1
(43) Pub. Date: Apr. 8, 2021

(54) FIRE RETARDANT COMPOSITE

(71) Applicant: Huntsman Advanced Materials Licensing (Switzerland) GMBH, Basel (CH)

(72) Inventors: Oliver De Verclos, Basel (CH); John Fraser, Billingham (GB)

(21) Appl. No.: 16/500,110

(22) PCT Filed: Apr. 12, 2018
(86) PCT No.: PCT/US2018/027317

§ 371 Date: Oct. 2, 2019

(30) Foreign Application Priority Data
Apr. 12, 2017 (EP) 17000619.1

(51) Int. Cl. B32B 27/38; B32B 15/092; B32B 15/20

(52) U.S. Cl. CPC B32B 27/38; B32B 15/092; B32B 2311/24; B32B 2363/00; B32B 15/20

(57) ABSTRACT

This disclosure relates to a fire-retardant composite material comprising a fibre-reinforced plastic covered by an aluminium foil and its application in passenger transport industries such as aerospace, railway or marine.

### CROSS REFERENCE TO RELATED APPLICATIONS

This application claims the benefit of European Patent Application Serial Number 17000619.1, filed Apr. 12, 2017, the entire disclosure of which is incorporated herein by reference.

### STATEMENT REGARDING FEDERALLY SPONSORED RESEARCH OR DEVELOPMENT

Not applicable

### FIELD OF INVENTION

The present disclosure relates to a fire-retardant composite material and its application in the transportation industry.

### BACKGROUND

Composite materials are presently produced, for example, by impregnating a fabric of carbon, glass, aramide or natural fibers with a liquid curable system typically comprising a thermosetting resin in combination with a suitable hardener and afterwards curing the impregnated fabric at room temperature or higher temperatures from a few minutes up to some days.

Methods for preparing such composites can be found, for example, in U.S. Pat. No. 4,107,128 or 6,485,834.

Typical reinforcements for composites are carbon, glass, aramide or natural fibers, while typical curable systems comprise, for example, epoxy resins, phenolic resins, polyurethanes and benzoxazines, if necessary, in combination with suitable hardeners, which after curing build a solid matrix exhibiting mechanical strength and elastic properties.

Composite materials combine low weight with high mechanical stability and are therefore suitable for construction and transport (e.g., automotive, railway, navy, aerospace) applications.

However, the requirements with respect to fire resistance and flame retardance, in particular in applications for the transportation of passengers, are getting stricter and conventional thermosetting materials based on phenolic resins do not combine fire resistance performance, high thermo-mechanical performance and processing via direct liquid processes. Other thermoset solutions suitable for direct liquid processing and providing high mechanical performance do not pass the most stringent FST (fire, smoke, toxicity) and HR (heat release) tests.

Accordingly, there is a demand for a composite material which fulfils the strictest FST and HR requirements and concurrently exhibits outstanding thermomechanical properties when the matrix is processed by direct liquid process (as opposed to indirect process such a prepregs).

It has now been found that this problem can be solved by the incorporation of a thin aluminium foil at a certain position of the composite.

### DETAILED DESCRIPTION

Unless otherwise defined herein, technical terms used in connection with the present disclosure shall have the meanings that are commonly understood by those having ordinary skill in the art. Further, unless otherwise required by context, singular terms shall include pluralities and plural terms shall include the singular.

All patents, published patent applications, and non-patent publications mentioned in the specification are indicative of the level of skill of those skilled in the art to which the present disclosure pertains. All patents, published patent applications, and non-patent publications referenced in any portion of this application are herein expressly incorporated by reference in their entirety to the same extent as if each individual patent or publication was specifically and individually indicated to be incorporated by reference to the extent that they do not contradict the instant disclosure.

The following terms shall have the following meanings:

The term “comprising” and derivatives thereof are not intended to exclude the presence of any additional component, step or procedure, whether or not the same is disclosed herein. In order to avoid any doubt, all compositions claimed herein through use of the term “comprising” may include any additional additive or compound, unless stated to the contrary. In contrast, the term, “consisting essentially of”, if appearing herein, excludes from the scope of any succeeding recitation any other component, step or procedure, excepting those that are not essential to operability and the term “consisting of”, if used, excludes any component, step or procedure not specifically delineated or listed. The term “or”, unless stated otherwise, refers to the listed members individually as well as in any combination.

The articles “a” and “an” are used herein to refer to one or more than one (i.e. to at least one) of the grammatical object of the article. By way of example, “an epoxy resin” means one epoxy resin or more than one epoxy resin.

The phrases “in one embodiment”, “in an embodiment”, “according to one embodiment”, and the like generally mean the particular feature, structure, or characteristic following the phrase is included in at least one embodiment of the present disclosure, and may be included in more than one embodiment of the present disclosure. Importantly, such phrases are non-limiting and do not necessarily refer to the same embodiment but, of course, can refer to one or more preceding and/or succeeding embodiments. For example, in the appended claims, any of the claimed embodiments can be used in any combination.

The present disclosure relates to a fire-retardant composite material comprising a fibre-reinforced plastic covered by an aluminium foil.

Especially preferred fibres are glass fibres and, in particular, carbon fibres.

Such fibers provide the required mechanical strength.

According to a further preferred embodiment, the composite material comprises 20 to 80 vol. %, preferably 35 to 65 vol. %, more preferably 40 to 60 vol. % of fibers, based on the total volume of the composite.

If the volume percentage of fibers is too high, there will not be enough matrix to transfer efforts between the fibres. If the volume fraction of fibers is too low, the quantity of resin will be favourable to burning behavior.

In a preferred embodiment, the composite material may have a monolithic structure, wherein the aluminium foil is covered by a further sheet of fibre-reinforced plastic.

In a further preferred embodiment, the composite material may have a sandwich structure, wherein an inner core is coated on both sides with a fibre-reinforced plastic and the outer surface of the assembly is covered by an aluminium foil.

In a further embodiment, in said composite material having a sandwich structure the aluminium foil may be covered by a further sheet of fibre-reinforced plastic, preferably mineral-fibre-reinforced plastic, in particular glass-fibre-reinforced plastic.

Matrix resins for the preparation of the fibre-reinforced plastic are well-known to the skilled artisan.

Phenolic resins provide satisfactory FST and HR tests, but the mechanical properties of the cured products are inadequate for certain applications.

The thermomechanical properties of products obtained from benzoxazines as matrix resins are good. However, the curing rates of benzoxazines are unacceptably low.

For these reasons, epoxy resins are the preferred matrix resins.

Recently, a class of epoxy resins which are particularly suitable for automotive, marine and aerospace applications requiring high FST and HR standards, have been offered under the designation ARALDITE® FST (supplied by Huntsman Corporation, or an affiliate thereof, The Woodlands, Tex.).

Different qualities and the thicknesses of the aluminium foil may be used for the concept of the present disclosure. However, in view of the desired low weight of the composite, the thickness of the foil should not exceed 5.0 mm.

Preferably, the foil has a thickness of 0.01 mm-5.0 mm, more preferably 0.02-0.5 mm, or more preferably 0.05 mm-0.3 mm.

The impregnation and curing process is well-known in the art and sufficiently described in the technical literature.

The following Examples serve to illustrate the presently disclosed composite. Unless otherwise indicated, the temperatures are given in degrees Celsius, parts are parts by weight and percentages relate to % by weight. Parts by weight relate to parts by volume in a ratio of kilograms to litres.

### Example 1

One layer of carbon fabric (300 g/m²) covered by two layers of glass fabric (600 g/m² each) is provided. An aluminium foil of 0.1 mm thickness is positioned above the glass fabrics and a glass fabric (50-90 g/m²) is placed on the other side of the aluminium foil. The composite lay-up so obtained is impregnated with a liquid epoxy resin (ARALDITE® FST 40002/LME 11227 flame resistant resin). Subsequently, the composite material is cured (12 min/130° C. and 3 h/165° C.).

### Comparative Example 1

Example 1 is repeated under omission of the aluminium foil.

### Example 2

Example 1 is repeated with an additional decorative layer applied on the surface of the 50-90 g/m² glass fabric.

### Comparative Example 2

Example 2 is repeated under omission of the aluminium foil.

### Example 3

A composite sandwich structure is prepared by applying a layer of carbon fabric (300 g/m²) on one side of a core consisting of a 3 mm thick PEI (polyetherimide) honeycomb. A layer of glass fabric (220 g/m²) is applied on the other side of the core. An aluminium foil of 0.05 mm thickness is applied on the outer surface of glass fabric and a glass fabric (50-90 g/m²) is placed on the other side of the aluminium foil. The composite material so obtained is impregnated with the liquid epoxy resin. Subsequently, the composite material is cured (12 min/130° C. and 3 h/165° C.).

### Comparative Example 3

Example 3 is repeated under omission of the aluminium foil.

### Example 4

Example 3 is repeated with an additional decorative layer applied on the surface of the glass fabric.

The cured composites are tested with respect to aerospace standard FAR25-853 (Heat release tests). The results are summarized in Table 1.

TABLE 1

| | | Comp. | | Comp. | | Comp. | |
|---|---|---|---|---|---|---|---|
| | Ex. 1 | Ex. 1 | Ex. 2 | Ex. 2 | Ex. 3 | Ex. 3 | Ex. 4 |
| HR/kWmin/m² | 26.5 | 49.3 | 53.7 | 65.9 | 56.2 | 68.6 | 65.0 |
| HRR/kW/m² | 35.7 | 52.2 | 53.9 | 75.0 | 56.1 | 57.7 | 58.3 |
| Peak time/s | 104.0 | 52.0 | 45.0 | 42.0 | 78.0 | 73.0 | 27.0 |

HR: Heat release
HRR: Heat release rate

For aerospace applications, values of HR<65 kWmin/m² and HRR <65 kW/m² are usually required. The examples above of the presently disclosed composite materials show improved HR and HRR results over the respective comparative examples.

The above-disclosed subject matter is to be considered illustrative, and not restrictive, and the appended claims are intended to cover all such modifications, enhancements, and other embodiments, which fall within the true scope of the present disclosure. Thus, to the maximum extent allowed by law, the scope of the present disclosure is to be determined by the broadest permissible interpretation of the following claims and their equivalents, and shall not be restricted or limited by the foregoing detailed description.

1. A fire-retardant composite material comprising a fibre-reinforced plastic covered by an aluminium foil.

2. The fire-retardant composite material according to claim 1, wherein the composite material has a monolithic structure, and wherein the aluminium foil is covered by a further sheet of fibre-reinforced plastic.

3. The fire-retardant composite material according to claim 1, wherein the composite material has a sandwich structure, wherein an inner core is coated on both sides with a fibre-reinforced plastic and the outer surface of the assembly is covered by an aluminium foil.

4. The fire-retardant composite material according to claim 3, wherein the aluminium foil is covered by a further sheet of fibre-reinforced plastic.

5. The fire-retardant composite material according to claim 4, wherein said further sheet contains mineral-fibre-reinforced plastic.

6. The fire-retardant composite material according to claim 1, wherein the fibre-reinforced plastic contains a thermosetting resin as matrix resin.

7. The fire-retardant composite material according to claim 1, wherein the fibre-reinforced plastic contains an epoxy resin as matrix resin.

8. The fire-retardant composite material according to claim 1, wherein the aluminium foil has a thickness of 0.01 mm-5.0 mm.
